(19) United States
(12) Patent Application Publication
(10) Pub. No.: US 2026/0105303 A1
(43) Pub. Date: Apr. 16, 2026

(54) SYSTEM STATE DETECTION METHOD AND SYSTEM FOR INDUSTRIAL INTERNET SYSTEM, DEVICE AND MEDIUM

(71) Applicant: BEIHANG UNIVERSITY, Beijing (CN)

(72) Inventors: Lei REN, Beijing (CN); Yusheng KONG, Beijing (CN); Jingwei GUO, Beijing (CN)

(73) Assignee: BEIHANG UNIVERSITY, Beijing (CN)

(21) Appl. No.: 19/357,399

(22) Filed: Oct. 14, 2025

(30) Foreign Application Priority Data
Oct. 14, 2024 (CN) 202411427290.8

(51) Int. Cl. G06N 3/08

(52) U.S. Cl. CPC G06N 3/08

(57) ABSTRACT

A system state detection method and system for an industrial internet system, a device and a medium, all related to the field of industrial internet. The method includes: acquiring system data of the industrial internet system; detecting the system data by using a system state detection model to obtain a system state of the industrial internet system; where the system state detection model includes a shallow-layer feature extraction module and a plurality of deep-layer feature detection modules connected in sequence, the system state detection model is obtained by training a dynamic neural network model by using a training data set, the training data set includes historical system data of the industrial internet system, and the system state includes system normality and system abnormality; and in a case that the system state is system abnormality, outputting the system state of the industrial internet system.

### CROSS-REFERENCE TO RELATED APPLICATION

The present application claims priority to Chinese Application No. 202411427290.8, filed on Oct. 14, 2024, which is hereby incorporated by reference in its entirety.

### TECHNICAL FIELD

The present application relates to the technical field of industrial internet and, in particular, to system state detection method and system for an industrial internet system, a device and a medium.

### BACKGROUND

With the rapid development of manufacturing industry and the diversification of market demand, industrial internet system has been widely used in modern industrial production. Industrial internet system is a system that combines a traditional industrial device with Internet technology, which realizes intelligentization, interconnection and automation of industrial device by means of sensors, communication technology, big data analysis and cloud computing, and so on.

However, during the production process of the industrial internet system, various abnormal situations often occur, such as device failure, process deviation, material shortage and so on. If these abnormal situations are not found and handled in time, not only production efficiency would be affected, but also quality problems of the product will be caused and even safety accidents would be caused. Therefore, it is of great significance to effectively monitor the system state of the industrial internet system.

In recent years, with the wide application of deep learning, the system state detection for the industrial internet system based on deep learning has attracted more and more attention. However, due to the increasing depth of neural network model, the state detection efficiency of the existing intelligent industrial internet system is low.

### SUMMARY

The present application provides system state detection method and system for an industrial internet system, a device and a medium, which are used for solving the problem of low state detection efficiency of the existing industrial internet system and realizing the improvement of the detection efficiency of the industrial internet system.

In a first aspect, the present application provides a system state detection method for an industrial internet system, including:
acquiring system data of the industrial internet system;
detecting the system data by using a system state detection model to obtain a system state of the industrial internet system; where the system state detection model includes a shallow-layer feature extraction module and a plurality of deep-layer feature detection modules connected in sequence, the system state detection model is obtained by training a dynamic neural network model by using a training data set, the training data set includes historical system data of the industrial internet system, and the system state includes system normality and system abnormality; and
in a case that the system state is system abnormality, outputting the system state of the industrial internet system.

In an implementation, the detecting the system data by using the system state detection model to obtain the system state of the industrial internet system includes:
inputting the system data into the shallow-layer feature extraction module to obtain corresponding shallow-layer feature extraction data;
for a deep-layer feature detection module at any level except a last level, inputting shallow-layer feature data output by the shallow-layer feature extraction module or a deep-layer feature detection module at a previous level to a deep-layer feature detection module at a current level for deep-layer feature extraction, and performing state detection on extracted deep-layer feature data to obtain a corresponding system state and a confidence corresponding to the system state;
in a case that the confidence does not meet a preset confidence threshold condition, outputting deep-layer feature data of the current level as shallow-layer feature data of a deep-layer feature detection module at a next level; and
in a case that the confidence meets the confidence threshold condition, outputting a detection state of the current level as the system state corresponding to the industrial internet system.

In an implementation, the deep-layer feature detection module at any level except the last level includes a deep-layer feature extraction and state detection submodule, and a detection result checking submodule;
where the deep-layer feature extraction and state detection submodule is configured to perform deep-layer feature extraction on the shallow-layer feature data output by the shallow-layer feature extraction module or the deep-layer feature detection module at the previous level, and perform state detection on the extracted deep-layer feature data to obtain the corresponding system state;
the detection result checking submodule is configured to obtain the confidence corresponding to the system state, where in the case that the confidence does not meet the preset confidence threshold condition, the deep-layer feature data of the current layer is taken as the shallow-layer feature data of the deep-layer feature detection module at the next level; and in the case that the confidence meets the confidence threshold condition, the system state corresponding to the industrial internet system is obtained.

In an implementation, the deep-layer feature extraction and state detection submodule includes a deep-layer feature extraction layer and a state detection layer;
the deep-layer feature extraction layer is configured to perform deep-layer feature extraction on the shallow-layer feature data output by the shallow-layer feature extraction module or the deep-layer feature detection module at the previous level to obtain the deep-layer feature data;
the state detection layer is configured to perform state detection on the extracted deep-layer feature data to obtain the corresponding system state.

In an implementation, the confidence threshold condition includes a first threshold and a second threshold; the first threshold is less than the second threshold;
the confidence doing not meet the preset confidence threshold condition includes that the confidence is less than the first threshold, or the confidence is great than the second threshold;
the confidence meeting the confidence threshold condition includes that the confidence is great than the first threshold and the confidence is less than the second threshold.

In an implementation, the method further includes:
training a constructed dynamic neural network model by using the training data set to obtain the system state detection model, where a loss function used in training includes regression loss, correlation difference loss and feature unwrapping loss, the correlation difference loss includes prior correlation loss and sequence correlation loss,
where the regression loss represents a difference between a reconstruction result of the historical system data output by the dynamic neural network model in a training process and the historical system data;
the prior correlation loss represents an attention weight distribution of a corresponding row of the historical system data in an attention matrix;
the sequence correlation loss represents a correlation between deep-layer feature data respectively corresponding to a current data point and a neighborhood data point in the historical system data;
the feature unwrapping loss represents a degree of correlation between deep-layer feature data corresponding to different data points in the historical system data.

In a second aspect, the present application provides a system state detection system for an industrial internet system, including: a system data acquisition subsystem, a system state detection subsystem and a system state alarm subsystem; where,
where the system data acquisition subsystem is configured to acquire system data of an industrial internet system and transmit the system data to the system state detection subsystem;
the system state detection subsystem is configured to execute the system state detection method for the industrial internet system according to any of the first aspect;
the system state alarm subsystem is configured to alarm the system state output by the system state detection subsystem.

In a third aspect, the present application provides an electronic device, including: a processor and a memory communicatively connected with the processor;
the memory store computer executable instructions; and
the processor, when executing the computer executable instructions stored in the memory, is configured to realize the method according to the first aspect.

In a fourth aspect, the present application provides a computer-readable storage medium, where the computer-readable storage medium stores computer executable instructions, and when the computer executable instructions are executed by a processor, the method according to the first aspect is implemented.

In a fifth aspect, the present application provides a computer program product, where the computer program product includes a computer program which, when executed by a processor, implements the method according to the first aspect.

The system state detection method for the industrial internet system provided by the present application acquires system data of the industrial internet system; detects the system data by using a system state detection model to obtain a system state of the industrial internet system; where the system state detection model includes a shallow-layer feature extraction module and a plurality of deep-layer feature detection modules connected in sequence, the system state detection model is obtained by training a dynamic neural network model by using a training data set, the training data set includes historical system data of the industrial internet system, and the system state includes system normality and system abnormality; and in a case that the system state is system abnormality, outputs the system state of the industrial internet system. In the above scheme, shallow-layer feature extraction is performed on the collected system data, and when the plurality of deep-layer feature detection modules connected in sequence are adopted for state detection subsequently, a deep-layer feature detection module at a shallower level is firstly used for deep-layer feature extraction and state detection, and the detection is directly ended when the detection result is satisfactory. Secondly, a detection module at a deeper level is adopted to continue the detection when the detection result is not satisfactory. In this way, the detection can be ended when a satisfactory detection result can be obtained by using the deep-layer feature detection modules at the shallower level, so as to reduce usage of full-depth detection modules for state detection, thus reducing the high calculation amount of the model, realizing deployment of model for the state detection under the condition of insufficient computing power at the edge, therefore, realizing state detection model that performs state detection for the industrial internet system and thus efficient detection for the network state of the industrial internet.

### BRIEF DESCRIPTION OF DRAWINGS

The accompanying drawings, which are incorporated in and constitute a part of this specification, illustrate embodiments consistent with the present application and together with the description, serve to explain the principles of the present application.

FIG. 1 is a flowchart of a system state detection method for an industrial internet system provided by an embodiment of the present application.

FIG. 2 is a structural schematic diagram 1 of a system state detection model provided by an embodiment of the present application.

FIG. 3 is a structural schematic diagram 2 of a system state detection model provided by an embodiment of the present application.

FIG. 4 is a structural schematic diagram 3 of a system state detection model provided by an embodiment of the present application.

FIG. 5 is a schematic structural diagram of a system state detection system for an industrial internet system provided by an embodiment of the present application.

FIG. 6 is a block diagram of an electronic device provided by an embodiment of the present application.

Through the above drawings, clear embodiments of the present application has been shown, which will be described in more detail below. These drawings and written descriptions are not intended to limit the scope of the concept of the present application in any way, but to explain the concept of the present application to those skilled in the art by referring to specific embodiments.

### DETAILED DESCRIPTION OF EMBODIMENTS

Reference will now be made in detail to exemplary embodiments, examples of which are illustrated in the accompanying drawings. When the following description refers to the drawings, unless otherwise indicated, the same numbers in different drawings indicate the same or similar elements. The implementations described in the following exemplary embodiments do not represent all implementations consistent with the present application. Rather, they are merely examples of apparatuses and methods consistent with some aspects of the present application as detailed in the appended claims.

In modern industrial production, various abnormal situations often occur, such as device failure, process deviation, material shortage and so on. If these abnormal situations are not found and handled in time, not only production efficiency would be affected, but also quality problems of the product will be caused, further, even safety accidents would be caused. Therefore, it is of great significance to effectively monitor the system state of the industrial internet system.

Among the system state detection methods corresponding to the industrial internet system, a large number of traditional methods mainly include clustering-based method, density-based method, isolation-based method and distance-based method. In recent years, with the wide application of deep learning, supervised detection method, semi-supervised detection method and unsupervised detection method based on deep learning have attracted more and more attention.

In some implementations, for the supervised deep learning detection method, Potluri et al. proposed a detection method based on convolutional neural network (CNN). Firstly, the feature vector is converted into an 8*8 pixel image, and then a three-layer CNN is constructed to classify attacks. Yang et al. proposed an iFinger fingerprinting method, which uses CNN to predict network traffic volume, and determines whether the industrial internet was attacked based on a difference between a predicted traffic volume and a real traffic volume. Li et al. proposed a deep learning anomaly detection method based on multi-convolutional neural network (multi-CNN) fusion to make full use of weakly correlated feature data samples to establish a classification model, so as to identify abnormal data of the industrial internet. Zhou et al. proposed a learning model of variational long-short-term memory network (Long-Short-Term Memory, LSTM), in which a variational re-parametric compression (encoding and decoding) network and an estimation network for low-dimensional feature representation were constructed to solve the problem of unbalanced data distribution in high-dimensional feature anomaly detection for intelligent industrial applications in the industrial internet. Chen et al. adopted a CNN-BiLSTM network structure to extract cross-domain sample features to further improve feature expression ability.

In other implementations, for unsupervised deep learning detection method, Zhang et al. extracted features based on sparse self-encoder, sampled unbalanced data sets by using synthetic minority over-sampling technique (SMOTE) and detected attacks by using XGBoost model. Sparse self-encoder introduces sparse constraints into an original self-encoder to enhance a detection ability for unknown samples. SMOTE algorithm oversamples minority categories and divides majority categories into many subcategories, so that each category reaches a balance. Kravchik et al. used an improved undercomplete auto-encoder (UAE) to perform attacks detection according to both time domain features and frequency domain features. Liu et al. introduced regularized sparse deep belief network (RSDBN) model to model abnormal behavior. RSDBN used unsupervised and restricted Boltzmann machine to train a model layer by layer for potential attack detection of information system, which effectively achieved high detection accuracy and low false alarm rate. Antagonistic learning method can improve a detection accuracy for small data sets. Zhang et al. adopted GAN for data enhancement, and added the generated data to the training set, which can detect the variation of the attack. Chen et al. proposed a defense method against attacks based on GAN against covert network attacks such as injection attack, function code attack and reconnaissance attack. Deep reinforcement learning can combine the perception ability of deep learning with the decision-making ability of reinforcement learning. Qiu et al. developed a method based on dueling deep Q-learning to deal with the network threats faced by secure communication in the industrial internet.

In some implementations, for the semi-supervised deep learning detection method, Aouedi et al. first trained a self-encoder AE on each device using unlabeled local private data to learn low-dimensional features, then a cloud server aggregated these models into the global AE using federated learning, and finally the cloud server formed a supervised neural network by adding a full connection layer to the global AE encoder, and trained a final model using publicly available tagged data. Hassan et al. proposed a semi-supervised network attack detection model for the industrial internet based on deep learning. The model is divided into two layers. Firstly, in an unsupervised layer, features of labeled data and unlabeled data are extracted by a stacking-restricted Boltzmann network, and then a supervised layer uses support vector machine and random forest method to train a elastic classifier model to detect unlabeled attacks. This method uses unsupervised learning and utilizes unlabeled data to learn the rapid changes of unknown attack models, therefore, it possesses strong adaptability to emerging network attacks and their dynamic characteristics. Xu et al. found that the distribution of self-attention weight at each time point can reflect the correlation with the whole sequence, further, due to the scarcity of abnormal values, the correlation between points of abnormal values and the whole sequence is relatively low, which reflects the inherent difference between normal points and abnormal points. Further, it is proposed an Anomaly-Transformer structure with Anomaly-Attention mechanism to calculate the correlation difference. Qiu et al. proposed a fast and stable unsupervised anomaly detection (USAD) method of multivariable time sequence based on reverse training self-encoder, an automatic encoder structure of which enables it to learn in an unsupervised way, and the usage of antagonistic training and its architecture allows it to find attacks while providing rapid training.

However, the current detection methods based on deep learning basically have the problem of high model complexity, which greatly increases the security cost of the device where the system is located when the industrial internet system performs system state detection, which also puts forward certain requirements for the computing power of the device where the system is located, thus leading to the industrial internet system unfavorable for deploying under a condition of insufficient computing power at the edge, that is, there are problems such as low state detection efficiency of the industrial internet system and affecting industrial production efficiency.

The system state detection method for the industrial internet system provided by the present application aims to solve the above technical problems in the prior art. Specifically, firstly, a detection module at a shallower level among a plurality of deep-layer feature detection modules connected in sequence is used to perform detection, and when the detection result is satisfactory, the detection is ended; in a case that the detection result is unsatisfactory, a deeper-layer detection module is used to continue to perform the detection, so as to reduce a detection times by using a detection module with full-depth, thereby reducing the calculation amount of the model to a certain extent and improving detection efficiency. In other words, if the detection result of the deep-layer feature detection module at the shallower-level hardly contains system anomalies or is almost filled with system anomalies, it is unnecessary to use the deep-layer feature detection module at a deeper level to further extract a feature and perform detection. When the output result of the deep-layer feature detection module at the shallower level contains both system abnormality and system normality, a detection module at the deeper level can be used to extract a feature at a deeper level and perform the detection, so as to obtain a more accurate detection result, thus reducing the amount of data calculation as much as possible under a condition of ensuring the prediction accuracy, thus solving the problem of low efficiency of the state detection of the existing industrial internet system, realizing deployment of model for the state detection under the condition of insufficient computing power at the edge, therefore, realizing state detection model that performs state detection for the industrial internet system and thus efficient detection for the network state of the industrial internet.

Industrial internet system is a system that combines a traditional industrial device with Internet technology and has wide application range, including manufacturing, energy, transportation, medical care and other fields. Its main advantages lie in improving production efficiency, reducing operating costs, improving product quality and realizing intelligent management. The application scenario of the technical scheme of the present application can be applied to the scenario of performing state detection on industrial internet systems deployed in any field to ensure smooth production. For any scenario, this scheme includes a data acquisition device, a data processing device and a status alarm device.

In a production process, firstly, the industrial internet system converts a received order into a task list and generates a production scheduling plan corresponding to the task list. On this basis, the industrial internet system controls a stacker to accurately grab a pallet filled with raw materials according to the production scheduling plan, and puts the pallet on the discharge conveyor line, so as to control a material conveying equipment to pick and distribute the materials, and control an automated guided vehicle (AGV) to automatically distribute the sorted materials. Specifically, AGV automatically transports the raw material pallet to a processing machine for material assembly. The present application does not limit the type of the first AGV, and an example of which can be a belt-line composite AGV

Secondly, the industrial internet system also controls the cooperative mechanical arm to flexibly and automatically assemble the materials delivered to a processing machine. The industrial internet system can realize a clamping state for different materials by controlling the mechanical arm to install fixtures corresponding to different materials, and finally realize intelligent assembly for product, and control an automatic transportation of the assembled finished product to the intelligent packaging equipment. A three-axis module in the intelligent packaging equipment firstly clamps a bottom cover and puts it into a packaging station. Then, the clamped product is put into the bottom cover, a lid cover is clamped and accurately buckled after ensuring that the product is put into the bottom cover smoothly, and a two-dimensional code label printed with product information is attached to a packaging box by a labeling machine.

Finally, the industrial internet system controls a product packaging equipment to put the packaged finished product into a product warehouse, so as to realize the delivery for a received order.

In the above-mentioned production process, the industrial internet system includes a plurality of production equipment and a control system corresponding to each production equipment. During a real-time production operation of each production equipment, corresponding operation data of each production equipment will be generated. A data acquisition device includes a plurality of sensing devices, and each sensing device is used for sensing the operation data of each production device in the industrial internet system in the production operation process, that is, obtaining system data of the industrial internet system in the production process, and delivering the above system data to the data processing device.

The industrial internet system can perform data transmission through various communication networks. Exemplary, the various communication networks include Ethernet, wireless networks (such as Wi-Fi and 5G), industrial buses (such as Modbus and Profibus), and so on.

When the data processing equipment receives the system data, it first performs a shallow layer feature extraction, which is convenient for a subsequent deep layer feature extraction and state detection. Furthermore, a detection module at a shallower level among a plurality of deep-layer detection modules connected in sequence is adopted to perform a detection, when the detection result is satisfactory, the detection is ended, and when the detection result is unsatisfactory, the detection is continued by using a detection module at a deeper level, so as to reduce the usage of full-depth detection modules for detection, thus reducing the high calculation amount of the model, realizing deployment of model for the state detection under the condition of insufficient computing power at the edge, therefore, realizing state detection model that performs state detection for the industrial internet system and thus efficient detection for the network state of the industrial internet.

When the data processing equipment determines that the state detection result of the industrial internet system is system abnormality, the data processing equipment outputs an alarm signal corresponding to the abnormal state to an alarm device, and the alarm device makes an alarm for indication and prompts to remind the staff that the industrial internet system is abnormal, so that the production staff can quickly respond to the alarm of the system abnormality and maintain the current industrial internet system.

The technical scheme of the present application and how the technical scheme of the present application can solve the above technical problems will be described in detail with specific examples. The following specific embodiments can be combined with each other, and the same or similar concepts or processes may not be repeated in some embodiments. Embodiments of the present application will be described below with reference to the accompanying drawings.

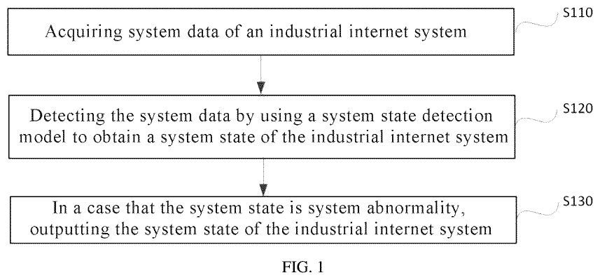

FIG. 1 is a flowchart of a system state detection method for an industrial internet system provided by an embodiment of the present application. The method can be executed by a system state detection apparatus of an industrial internet system, the system state detection apparatus of the industrial internet system can be deployed in a server or an electronic device. The following description take the system state detection apparatus being deployed in the electronic device for an example. The method in this embodiment can be implemented by software, hardware or a combination of software and hardware. As shown in FIG. 1, and the method includes the following steps.

S110: acquiring system data of the industrial internet system.

In the present application, the industrial internet system can be interpreted as a system that combines a traditional industrial device with Internet technology. According to the different application fields of the industrial internet system, different apparatuses and corresponding control systems can be configured in the industrial internet system to control product production through the industrial internet system.

In the following, the present application takes the industrial internet system in any field as an example to introduce the scheme illustratively. Specifically, in a current industrial internet system, a plurality of sensing devices can be pre-installed according to each apparatus in the industrial internet system, and each sensing device is respectively connected with each apparatus configured in the system, so as to collect and acquire apparatus data generated by each apparatus in a production process. The apparatus data includes, but is not limited to, apparatus type data corresponding to each apparatus and operation state data generated by each apparatus during operation.

In the production process, each apparatus can be monitored and analyzed by a vision device to obtain the apparatus type data corresponding to the apparatus. The vision device may include an image acquisition apparatus and a detection apparatus, and the detection apparatus detects the image acquired by the image acquisition device to obtain component type.

For part of the operation state data, they can also be directly obtained by reading digital signals in the control system corresponding to each production device in the industrial internet system, that is, for example, by collecting data in a supervisory control and data acquisition (SCADA) system.

In an exemplary embodiment of the present application, each apparatus of the industrial internet system may include a storage apparatus for storing materials, an assembly apparatus for distributing materials, a mechanical arm for assembling materials, and the like. For the storage apparatus, apparatus data includes running state and discharging type corresponding to a discharging conveyor line in the storage apparatus. For example, the operation state can be represented by a numerical value, where 0 represents static and 1 represents in transit. For the assembly apparatus, apparatus data can be coordinate data corresponding to a distribution trajectory and a distribution type. For the mechanical arm, apparatus data includes a corresponding fixture type when the mechanical arm clamps the material and spatial coordinate data of the mechanical arm relative to a base when the material is clamped. In some other embodiments, the industrial internet system may also include a packaging apparatus, and apparatus data corresponding to the apparatus may include but not limited to the types of packaging materials clamped by the three-axis module.

In this way, the system data of industrial internet system can be obtained according to the apparatus data generated by each apparatus in the production process. In other words, the system data in the present application includes the apparatus data corresponding to each apparatus in the industrial internet system.

On the one hand, the collected system data can be used for system state detection, on the other hand, the collected system data can be stored in the server to form big data, which is convenient for industrial data mining, industrial data analysis, industrial data statistics and other big data mining and analysis in a later stage.

S120: detecting the system data by using a system state detection model to obtain a system state of the industrial internet system.

The system state detection model includes a shallow-layer feature extraction module and a plurality of deep-layer feature detection modules connected in sequence.

In this application, the process of system state detection can be carried out in the industrial internet system, or in other terminal devices or servers communicating with the industrial internet system. It should be noted that the system state detection model can be trained in advance to improve the detection efficiency in the detection process no matter whether detection is performed in the industrial internet system or in other terminal devices or servers. If the detection is performed in other terminal devices or servers, the data needs to be transmitted to the computer or server which performs the detection when the system date is obtained.

In the detection process, the pre-trained system state detection model is retrieved, and the system data is input into the system state detection model for anomaly detection, so as to obtain the system state corresponding to the industrial internet system.

The system state detection model includes a shallow-layer feature extraction module and a deep-layer feature detection module, where the shallow-layer feature extraction module is configured to perform shallow-layer feature extraction on the system data input into the model, which is convenient for subsequent deep-layer feature extraction and state detection processing. In this way, compared with a case that a deep-layer feature is directly extracted by one feature extraction module, by using two feature extraction modules to perform feature extraction twice, feature extraction speed is increased and the improvement of detection efficiency is ensured.

In this application, the deep-layer feature detection module contained in the model is a plurality of deep-layer feature detection modules connected in sequence, and each deep-layer feature detection module includes the same network structure. In some detection implementations, the deeper the network structure is used to extract a feature at a deeper level, the richer information contained in the extracted feature, which is beneficial to improve the accuracy of the subsequent detection result. However, if all deep-layer feature detection modules are used for each group of data before state detection to extract the feature at the deepest level, a security overhead of the system where the model is located will be undoubtedly increased. In order to reduce unnecessary security overhead as much as possible while ensuring the prediction accuracy, in the system state detection model provided by the present application, if the detection result of the deep-layer feature detection module at the shallower level almost hardly contains system anomalies, or the detection result is almost filled with system anomalies, it is unnecessary to use the deep-layer feature detection module at a deeper level to further extract a feature and perform detection. When the output result of the deep-layer feature detection module at the shallower level contains both system abnormality and system normality, a deep-layer feature detection module at the deeper level is used to extract a feature at a deeper level and perform the detection. In this way, fewer deep-layer feature detection modules can be used in the model for processing, thus reducing the calculation amount of the model, realizing deployment of model for the state detection under the condition of insufficient computing power at the edge, therefore, realizing state detection model that performs state detection for the industrial internet system and thus efficient detection for the network state of the industrial internet.

S130: in a case that the system state is system abnormality, outputting the system state of the industrial internet system.

In this application, the detection result of the model for the system state includes system normality and system abnormality. In order to reduce the calculation amount of the system where the model is located and reduce the ineffective attention of the staff to the system, when the outputted detection result of the model is system normality, the detection result will only be stored in a preset storage location inside the system, and the system state is not outputted externally, that is, the system is in normal production state by default when there is no output result. On the other hand, when the outputted system state is detected, it means that the industrial internet system is abnormal, so that the staff can quickly pay attention to the abnormal state of the industrial internet system, realize rapid maintenance, and reduce production costs and security risks.

In order to reduce the amount of data stored in the model, the detection result of system normality stored in the model can be cleaned regularly.

In the application, the abnormal system state can be output to the alarm device. Specifically, the alarm device can include a billboard and an alarm set in the industrial internet system. The billboard and the alarm can be connected with the industrial internet system through wired or wireless network. The content displayed by the billboard includes warning information, task information and notification information, and the system state is displayed based on the collected data. When the system is abnormal, the warning information is displayed through the billboard, and an alarm is given through the alarm to remind the staff that the system is abnormal, and the abnormality can be quickly investigated and handled.

The system state detection method for the industrial internet system provided by the present application acquires system data of the industrial internet system; detects the system data by using a system state detection model to obtain a system state of the industrial internet system; where the system state detection model includes a shallow-layer feature extraction module and a plurality of deep-layer feature detection modules connected in sequence, the system state detection model is obtained by training a dynamic neural network model by using a training data set, the training data set includes historical system data of the industrial internet system, and the system state includes system normality and system abnormality; and in a case that the system state is system abnormality, outputs the system state of the industrial internet system. In the above scheme, shallow-layer feature extraction is performed on the collected system data, and when the plurality of deep-layer feature detection modules connected in sequence are adopted for state detection subsequently, a deep-layer feature detection module at a shallower level is firstly used for deep-layer feature extraction and state detection, and the detection is directly ended when the detection result is satisfactory. Secondly, a detection module at a deeper level is adopted to continue the detection when the detection result is not satisfactory. In this way, the detection can be ended when a satisfactory detection result can be obtained by using the deep-layer feature detection modules at the shallower level, so as to reduce usage of full-depth detection modules for state detection, thus reducing the high calculation amount of the model, realizing deployment of model for the state detection under the condition of insufficient computing power at the edge, therefore, realizing state detection model that performs state detection for the industrial internet system and thus efficient detection for the network state of the industrial internet.

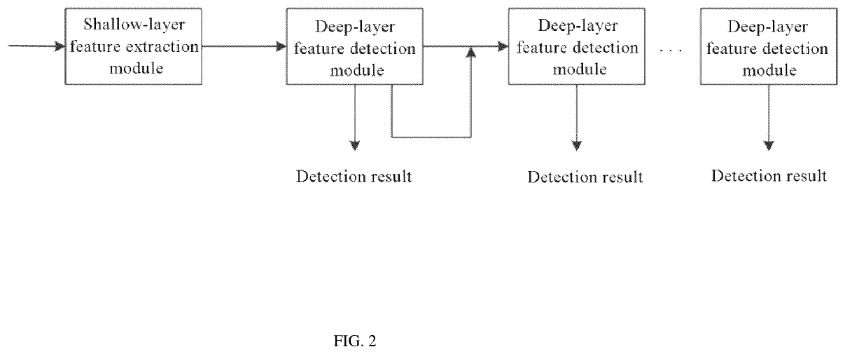

In the following, the model structure of the system state detection model used for detection is introduced in detail. FIG. 2 is a structural schematic diagram 1 of a system state detection model provided by an embodiment of the present application. Referring to FIG. 2, in this model, an input end of a shallow-layer feature extraction module is an input end of the system state detection model, and an output end of the shallow-layer feature extraction module is connected with an input end of a first deep-layer feature detection module; a first output end and a second output end of the deep-layer feature detection module at a first level are jointly connected with an input end of a deep-layer feature detection module at a next level; and a third output end of the deep-layer feature detection module at the first level is an output end of the system state detection model.

Further, for a deep-layer feature detection module at any intermediate level, an input end of the deep-layer feature detection module at any intermediate level is connected with a first output end and a second output end of a deep-layer feature detection module at a previous level, and a first output end and a second output end of the deep-layer feature detection module at the current level are also jointly connected with an input end of the deep-layer feature detection module at a next level; and a third output end of the deep-layer feature detection module at the current level can also be the output end of the system state detection model.

It should be understood that for a deep-layer feature detection module at a last level, an input end of the deep-layer feature detection module at the last level is also connected with a first output end and a second output end of a deep-layer feature detection module at a previous level. However, because there is no deep-layer feature detection module at a further next level, the deep-layer feature detection module at the last level does not have a first output end and a second output end, but only takes a third output end as the output end of the system state detection model. In other words, the first output end and the second output end thereof do not output data, but only output a final detection result of the model through the third output end.

In the present application, the detecting the system data by using the system state detection model to obtain the system state of the industrial internet system includes: inputting a shallow-layer feature corresponding to the system data into the shallow-layer feature extraction module to obtain corresponding shallow-layer feature extraction data; for a deep-layer feature detection module at any level except a last level, inputting shallow-layer feature data output by the shallow-layer feature extraction module or a deep-layer feature detection module at a previous level to a deep-layer feature detection module at a current level for deep-layer feature extraction, and performing state detection on extracted deep-layer feature data to obtain a corresponding system state and a confidence corresponding to the system state; in a case that the confidence does not meet a preset confidence threshold condition, outputting deep-layer feature data of the current level as shallow-layer feature data of a deep-layer feature detection module at a next level; and in a case that the confidence meets the confidence threshold condition, outputting a detection state of the current level as the system state corresponding to the industrial internet system.

Specifically, an output result of the shallow-layer feature extraction module is the shallow-layer feature data corresponding to the system data.

For the deep-layer feature detection module at any level except the last level, the shallow-layer feature data input into the deep-layer feature detection module at the current level will be subjected to deep-layer feature extraction and state detection processing. During the processing, a first output end outputs deep-layer feature data corresponding to the shallow-layer feature data in the deep-layer feature detection module at the current level, a second output end is a corresponding output channel in a case that a detection result corresponding to the deep-layer feature data does not meet a preset condition, and a third output end is a corresponding output channel in a case that the detection result corresponding to the deep-layer feature data meets the preset condition.

In other words, if the processing result of the deep-layer feature detection module at the current level meets the preset condition, the outputted detection result, that is, the system state, is output as the output result of the system state detection model. On the other hand, if the processing result of the deep-layer feature detection module at the current layer does not meet the preset condition, the corresponding detection result and the deep-layer feature data extracted at the current layer are input into a deep-layer feature detection module at a deeper level to realize continuous feature extraction and detection processing, and the detection result is output and the detection is stopped until the processing result of the deep-layer feature detection module at the deeper level meets the preset condition.

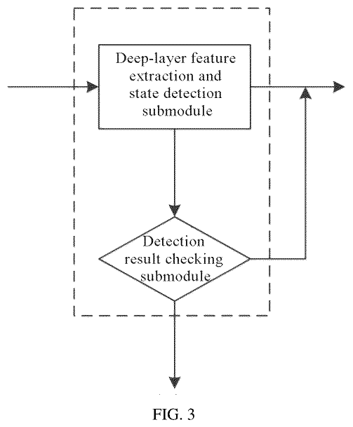

FIG. 3 is a structural schematic diagram 2 of a system state detection model provided by an embodiment of the present application. Referring to FIG. 3, on the basis of the above, in this model, the deep-layer feature detection module at any level except the last level includes a deep-layer feature extraction and state detection submodule, and a detection result checking submodule, where an input end of the deep-layer feature extraction and state detection submodule is the input end of the deep-layer feature detection module; a first output end of the deep-layer feature extraction and state detection submodule is connected with an input end of the detection result checking submodule; a second output end of the deep-layer feature extraction and state detection submodule and a first output end of the detection result checking submodule are respectively taken as the first output end and the second output end of the deep-layer feature detection module; and a second output end of the detection result checking submodule is the third output end of the deep-layer feature detection module.

In this application, the deep-layer feature extraction and state detection submodule is configured to perform deep-layer feature extraction on the shallow-layer feature data output by the shallow-layer feature extraction module or the deep-layer feature detection module at the previous level, and perform state detection on the extracted deep-layer feature data to obtain the corresponding system state; the detection result checking submodule is configured to obtain the confidence corresponding to the system state, where in the case that the confidence does not meet the preset confidence threshold condition, the deep-layer feature data of the current layer is taken as the shallow-layer feature data of the deep-layer feature detection module at the next level; and in the case that the confidence meets the confidence threshold condition, the system state corresponding to the industrial internet system is obtained.

Specifically, the deep-layer feature extraction and state detection submodule performs deep-layer feature extraction on the feature data output by the deep-layer feature detection module at the previous level or the shallow-layer feature extraction module to obtain the deep-layer feature data at the current level, and realizes state detection according to the deep-layer feature data to obtain the detection result output by the current level.

The detection result checking submodule determines whether the detection result output by the current level meets a preset threshold. If the detection result output by the current level meets the preset threshold, the detection result output by the current level is directly taken as the final detection result of the model, and the detection result is output through the second output end of the detection result checking submodule. Otherwise, if the detection result output by the current level does not meet the preset threshold, the deep-layer feature data output by the deep-layer feature extraction and state detection submodule and the corresponding detection results is output by the first output end of the detection result checking submodule for continually processing by the deep-layer feature detection module at the next level.

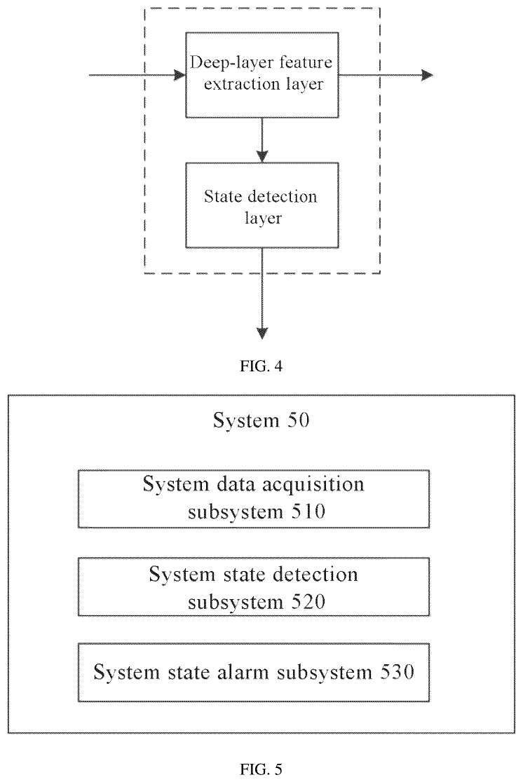

FIG. 4 is a structural schematic diagram 3 of a system state detection model provided by an embodiment of the present application. Referring to FIG. 4, on the basis of the above, in this model, the deep-layer feature extraction and state detection submodule includes a deep-layer feature extraction layer and a state detection layer, where an input end of the deep-layer feature extraction layer is the input end of the deep-layer feature extraction and state detection submodule, a first output end of the deep-layer feature extraction layer is connected with an input end of the state detection layer, a second output end of the deep-layer feature extraction layer is the second output end of the deep-layer feature extraction and state detection submodule, and an output end of the state detection layer is the first output end of the deep feature extraction and state detection submodule.

In this application, the deep-layer feature extraction layer is configured to perform deep-layer feature extraction on the shallow-layer feature data output by the shallow-layer feature extraction module or the deep-layer feature detection module at the previous level to obtain the deep-layer feature data; the state detection layer is configured to perform state detection on the extracted deep-layer feature data to obtain the corresponding system state.

Specifically, the deep-layer feature extraction module performs deep-layer feature extraction on the input data to obtain deep-layer feature data. On the one hand, the deep-layer feature data is used for state detection in the deep-layer feature detection module at the current level. On the other hand, in the case that the detection result output by the deep-layer feature detection module at the current level does not meet the preset condition, the detection result will be used as basic data and input into the deep-layer feature detection module at the next level for continue feature extraction and state detection.

The state detection layer performs state detection processing according to the deep-layer feature data extracted by the deep-layer feature extraction layer to obtain a detection result, and outputs the detection result to the detection result checking submodule in the deep-layer feature detection module at the current level for determination, so as to determine whether the detection result meets the preset condition, and further determine whether the state detection of the current group of data can output a result.

The above-mentioned network structure of the model can, on the one hand, control the deep-layer feature data generated at the current level to be output to the deep-layer feature detection module at the next level in the case that the detection result output by the deep-layer feature detection module at the current level does not meet the preset condition, so as to further realize feature extraction and detection processing at a deep level and improve the accuracy of the detection result; and, on the other hand, control, in a case that the detection result meeting the preset conditions is obtained, the detection result to be directly output as the detection result of the model, which can reduce unnecessary security overhead as much as possible while ensuring the prediction accuracy, improve the detection efficiency of the system, and reduce the production cost and security risks.

In the present application, the above-mentioned system state detection model could decide whether to end the task ahead of time based on a machine learning module built by a dynamic neural network through a “early quitting” mechanism in the dynamic neural network according to a satisfaction degree for the output result of the model. Therefore, a processing at a deeper level is avoided, thus avoiding redundant calculation by selectively skipping part of the structures, and reducing the calculation amount of the system where the model is located while ensuring the accuracy of the output results, realizing deployment of model for the state detection under the condition of insufficient computing power at the edge, therefore, realizing state detection model that performs state detection for the industrial internet system and thus efficient detection for the network state of the industrial internet.

In this application, on the basis of constructing an initial model based on a dynamic neural network, a constructed dynamic neural network model can be trained by using the training data set to obtain the system state detection model. In this application, the training data set includes historical system data of the industrial internet system.

As training a plurality of deep-layer feature detection modules at the same time will cause interference therebetween, in order to avoid the interference, the plurality of deep-layer feature detection modules contained in the model can be trained one by one based on the training data set.

It should be noted that in the actual production process, as there are few abnormal data in the industrial internet system, and the industrial internet data is difficult to be labeled, the dynamic neural network model of the present application adopts unsupervised learning, obtains historical apparatus data of each apparatus in the system at the normal working state to construct a training data set, and trains the shallow-layer feature extraction module and the deep-layer feature detection module of the dynamic neural network model one by one based on the training data set to obtain a trained dynamic neural network model, that is, the system state detection model.

In the training process, the shallow-layer feature extraction module and a first deep-layer feature detection module can be trained based on the training data set, and the loss can be calculated according to the output of the first deep-layer feature detection module, and then parameters of the shallow-layer feature extraction module and the first deep-layer feature detection module can be updated by back propagation until the training requirement is met. Secondly, the parameters of the shallow-layer feature extraction module and the first deep-layer feature detection module are fixed, the second deep-layer feature detection module is trained based on the training data set, and a loss is calculated according to the output of the second deep-layer feature detection module. Furthermore, a parameter of the second deep-layer feature detection module is updated by back propagation until the training requirement is met, and so on, until all the deep-layer feature detection modules are trained, and the trained system state detection model is obtained.

In the following, taking the training of deep-layer feature detection module at any level as an example, the training process of the model is introduced exemplarily.

In the training process, the historical system data in the training data set is obtained. In this application, the historical system data is multidimensional time series data, and the historical system data can be expressed in the form of X∈R^{L×K}, where L represents a data length and K represents a data dimension. It can be understood that the data dimension represents a type of data.

On the one hand, in order to match the network structure of the deep-layer feature detection module in the model, on the other hand, in order to obtain more abundant features in the data, the shallow-layer feature extraction module can perform a data feature extraction processing on the data to obtain shallow-layer feature corresponding to the historical system data.

In the process of shallow-layer feature extraction, firstly, data X is processed by one-dimensional convolution kernel, and a dimension of the historical system data is transformed from dimension k to dimension d_{model}, and data TE(X) is obtained.

Secondly, in order to provide position information of different time points in the historical system data, a position coding mechanism is used to perform a position coding processing on the data X, and data PE(X) is obtained.

Illustratively, the following expression is used to obtain a position code corresponding to the historical system data at each time point:

$${PE}_{pos 2 i} = sin ( pos / 510 {0}^{2 i / d} )$$

$${PE}_{pos , 2 i + 1} = cos ( pos / {5000}^{2 i / d} ) , i = 1 , … , d / 2$$

where d represents a dimension after dimensionality reduction, pos represents a position of the time point in a sample, PE_{pos, 2i} represent a value at even digits of the position coding, and PE_{pos, 2i+1} represent a value at odd digits of the position coding.

Finally, results of position coding and dimension transformation are fused to obtain shallow-layer feature data Z⁰.

Exemplary, a process of data fusion can refer to the following expression:

$${Z}^{0} = TE ( X ) + PE ( X )$$

In this application, the shallow-layer feature data output by the shallow-layer feature extraction module is input to the deep-layer feature detection module for further feature extraction processing to obtain deep-layer feature data Z¹. On the one hand, the deep-layer feature data is output to the deep-layer feature detection module at a next level, and on the other hand, the state detection is performed in the state detection layer at the current level, and the obtained detection result is checked in the detection result checking submodule.

In this application, the deep-layer feature extraction in the deep-layer feature detection module can be realized by Anomaly Attention mechanism. For example, in this mechanism, the deep-layer feature data can be obtained by the following expression:

$${Z}^{l} = {S}^{l} V$$

$${S}^{l} = Soft max ( \frac{{QK}^{T}}{\sqrt{d}} )$$

$$Q = {X}^{l - 1} {W}_{{Q}^{′}}^{l} K = {X}^{l - 1} {W}_{K}^{l} , V = {X}^{l - 1} {W}_{V}^{l}$$

where Softmax(⋅) represents a Softmax function, Z¹ represents deep-layer feature data output by a deep-layer feature detection module at a first level, d represents a dimension of the deep feature data,

$${W}_{Q}^{l}$$

represent a Q weight matrix of the deep-layer feature detection module at the first level,

$${W}_{K}^{l}$$

represents a K weight matrix of the deep-layer feature detection module at the first level, and

$${W}_{V}^{l}$$

represents a V weight matrix of the deep-layer feature detection module at the first level, Q, K and V respectively represent Query matrix, Keys matrix and Values matrix needed for calculating attention, and S¹ represents a sequence correlation between deep-layer feature data corresponding to the historical system data.

On this basis, a prior correlation P¹ between deep-layer feature data can also be calculated. Illustratively, the priori correlation can be calculated using a following expression:

$${p}^{l} = Rescale ( {[ \frac{1}{\sqrt{2 π {σ}_{i}}} exp ( - \frac{{\vert j - i \vert}^{2}}{2 {σ}_{i}^{2}} ) ]}_{i , j ∈ \{ 1 , … , L \}} )$$

where P¹ represents a prior correlation between the deep-layer feature data in the deep-layer feature detection module at the first level, σ represents a scale parameter matrix, σᵢ represents a scale parameter corresponding to the i-th historical system data, L represents the number of data points of the training sample, and Rescale(⋅) represents a rescale function.

Specifically, a time series dependence relationship in the historical system data can be mined through the sequence correlation and the prior correlation, so that the model can adaptively capture the most effective correlation, which is convenient for accurately extracting the data feature and provides a basis for subsequent detection.

It should be understood that the above-mentioned embodiments are only implementations introduced by way of example in the technical scheme of this application, and are not used as limitations to the technical scheme of this application. This application can also adopt any open-source manner to perform deep-layer feature extraction.

On the basis of obtaining the deep-layer feature data, the system state detection for the industrial internet system is performed according to the deep-layer feature data to obtain a predicted detection result output by the deep-layer feature detection module at the current level.

Specifically, the predicted detection result can be obtained by the following expression:

$${X}^{l} = Layer - Normal ( Feed - Forward ( {Z}^{l} ) + {Z}^{l} ) .$$

where X¹ represents a predicted detection result output by the deep-layer feature detection module at the first level, Layer-Normal(⋅) represents layer normalization, and Feed-Forward(⋅) represents a feed-forward unit.

On this basis, a loss function in the training process is constructed according to the above feature data, and the shallow-layer feature extraction module and the deep-layer feature detection module at the first level are trained by using the loss function.

The loss functions used in training in the present application include: regression loss, correlation difference loss and feature unwrapping loss, the correlation difference loss includes prior correlation loss and sequence correlation loss, the regression loss represents a difference between a reconstruction result of the historical system data output by the dynamic neural network model in a training process and the historical system data; the prior correlation loss represents an attention weight distribution of a corresponding row of the historical system data in an attention matrix; the sequence correlation loss represents a correlation between deep-layer feature data respectively corresponding to a current data point and a neighborhood data point in the historical system data; the feature unwrapping loss represents a degree of correlation between deep-layer feature data corresponding to different data points in the historical system data.

Specifically, the expression of the loss function can be obtained based on the following expression:

$${L}_{total}^{l} = {‖ {\hat{X}}^{l} - X ‖}_{F}^{2} - λ \times {AssDis}_{1}^{l} + {L}_{DAE}^{l}$$

where

$${L}_{total}^{l}$$

represents the loss function of the model and

$${‖ {\hat{X}}^{l} - X ‖}_{F}^{2}$$

represents a regression loss of the model; X represents the training data set, that is, the historical system data, and \hat{X}¹ represents a reconstruction result output by the deep-layer feature detection module at the first level. ∥⋅∥F represents a F norm, and ∥⋅∥1 represents a 1 norm, AssDis¹ represents the correlation difference loss of the model, and

$${L}_{DAE}^{l}$$

represents the feature unwrapping loss, and λ represents a parameter.

It should be understood that compared with normal data, abnormal data is difficult to establish a strong correlation relationship with the whole sequence dominated by a normal pattern, and it tends to pay more attention to adjacent areas (due to continuity). Therefore, this correlation difference with the whole sequence and adjacent priors provides a natural and strong discrimination criterion for anomaly detection.

Based on this, the smaller the correlation difference loss AssDis in this application, the greater the probability that the detection result is system abnormality. The greater the reconstruction error, the greater the probability that the detection result is system abnormality.

Specifically, the correlation difference loss in this application includes the prior correlation and the sequence correlation. Specifically, the correlation difference loss can be obtained based on the following expression:

$${{AssDis}^{l} = [ ( KL ( {P}_{i , :}^{l} ‖ {S}_{i , :}^{l} ) + KL ( {S}_{i , :}^{l} ‖ {P}_{i , :}^{l} ) ) ]}_{i = 1 , … , L}$$

$$where {P}_{i , :}^{l}$$

represents the prior correlation of the i-th data in the deep-layer feature detection module at the first level;

$${S}_{i , :}^{l}$$

Represents the sequence correlation of the i-th data in the deep-layer feature detection module at the first level, L represents the number of data points of the training sample, and KL(⋅∥⋅) represents a KL distance.

It should also be understood that the prior correlation adopts a learnable Gaussian kernel function, whose center is on an index of the corresponding time point. This design can make use of the unimodal characteristics of Gaussian distribution to make the data pay more attention to neighborhood points. At the same time, in order to make prior correlation adapt to different time series patterns, Gaussian kernel function contains a learnable scale σ parameter. The sequence correlation is obtained by attention calculation in standard Transformer, and the sequence correlation of a point is the attention weight distribution of the corresponding row of the point in the attention matrix. The purpose of this branch is to mine the correlation in the original sequence and let the model capture the most effective associations adaptively.

The correlation difference is a standard of anomaly measurement. The prior correlation adopts a normal distribution with unimodal characteristics. When an anomaly occurs, the neighboring points around the current point are likely to be abnormal, so both the prior correlation and the sequence correlation pay attention to local information, and thus there is a small difference between the two correlations. On a normal sequence, an attention mechanism of attention map has the characteristics of global attention, which will be distributed at non-adjacent points, such as periodic sequence, which is quite different from the obvious prior correlation with single peak.

It should also be understood that the time series data includes multiple dimensions, and features of some dimensions may be highly correlated, and the features of related dimensions usually include information redundancy, which is generally called feature wrapping.

In this application, when the model maps the deep-layer feature data to the reconstructed output, information redundancy may lead to deviation of anomaly detection results. In order to solve the problem that this situation may lead to a poor model result, the technical scheme provided by this application also designs a loss function L_{DAE} for representing feature unwrapping during model training, which is only calculated in a training stage, thus, it will not increase the computational complexity of the model in an application stage.

Specifically, in order to realize the feature unwrapping operation, a Pearson correlation coefficient between any two feature dimensions can be calculated first, so that a correlation degree between two variables can be measured between −1 and 1, and then a second moment Sₘₐᵢₙ corresponding to the correlation coefficient of the same dimension and a second moment Sₒₜₕₑᵣ corresponding to the correlation coefficient of different dimensions can be calculated, so as to reduce the overall correlation between different feature dimensions and avoid the influence of number of different summation elements.

Illustratively, the following expression can be used in this application to calculate the feature unwrapping loss:

$${L}_{DAE}^{l} = - {S}_{main}^{l} + {S}_{other}^{l}$$

$${S}_{main}^{l} = \frac{1}{d} {\sum }_{i ∈ [ 1 , d ]} {ρ ( {Z}_{: , i}^{l} , {Z}_{: , i}^{l} )}^{2}$$

$${S}_{other}^{l} = \frac{1}{{d}^{2} - d} {\sum }_{i , j ∈ [ 1 , d ] , i \neq j} {ρ ( {Z}_{: , i}^{l} , {Z}_{: , j}^{l} )}^{2}$$

where ρ (⋅, ⋅) represents the Pearson correlation coefficient, and d represents the number of dimension of feature data.

$${Z}_{: , i}^{l}$$

represents the feature data of the i-th dimension extracted by the deep-layer feature detection module at the first level and

$${Z}_{: , j}^{l}$$

represents a feature of the j-th dimension extracted by the deep-layer feature detection module at the first level.

In the application, by calculating the feature unwrapping loss, the difference between the correlation of the selected feature dimension itself and the correlation between the selected feature dimension and other feature dimensions can be widened, so as to reduce the entanglement distribution of statistical features, realize more accurate reconstruction, and further improve the sensitivity to feature changes caused by different attacks.

On the basis of obtaining the system state detection model after training, the process of using the system state detection model to detect the system data and obtain the system state corresponding to the industrial internet system can specifically include: extracting the shallow-layer feature of the system data to obtain shallow-layer feature data; performing the following steps of feature extraction and state detection until a system state meeting a preset condition is obtained, and determining the system state corresponding to the industrial internet system; performing deep-layer feature extraction on the shallow-layer feature data of the current layer to obtain deep-layer feature data corresponding to the current layer; where the shallow-layer feature includes the shallow feature data obtained after the shallow-layer feature extraction on system data, or the deep-layer feature data of a previous layer; performing state detection on the deep-layer feature data of the current layer to obtain the corresponding system state and the confidence corresponding to the system state; in a case that the confidence does not meet a preset confidence threshold condition, taking the deep-layer feature data of the current layer as the shallow-layer feature data of a next layer; and in a case that the confidence meets the confidence threshold condition, obtaining the corresponding system state of the industrial internet system.

Specifically, the shallow-layer feature extraction module in the model is used to perform shallow-layer feature extraction on the input system data to obtain the shallow-layer feature data; input the shallow-layer feature data into the deep-layer feature detection module for feature extraction and state detection processing at a deep level.

Specifically, the feature extraction at the deeper level is performed on the shallow-layer feature data to obtain deep-layer feature data, and state detection is performed according to the deep-layer feature data to obtain a state detection result. Further, if the state detection result meets the preset condition, it is output as the final output result of the model; on the other hand, if the state detection result does not meet the preset condition, the detection result and the deep-layer feature data are output to the deep-layer feature detection module at the next level for continue feature extraction and detection processing until the detection result is output.

In this application, the confidence corresponding to the detection result can be calculated, and whether the detection result meets the preset condition can be determined according to the preset confidence threshold and the confidence corresponding to the detection result.

Specifically, an anomaly score corresponding to the detection result can be calculated in advance, and the confidence can be obtained by calculating according to the anomaly score. It should be noted that the anomaly score Anomaly Score is a vector with a length of L, and each element thereof represents a probability that the corresponding data point in the sample is an abnormal point.

Furthermore, each element in the Anomaly Score vector is compared with an anomaly threshold, and if it is greater than or equal to the anomaly threshold, the element is marked as an abnormal data point, otherwise it is marked as a normal data point. Then, the confidence is obtained according to a proportion of the abnormal data point, that is, a ratio of the abnormal data point to the number of elements in the anomaly score is calculated to obtain the confidence. Considering a sparsity of abnormal data in an anomaly detection task, finding all abnormal points as much as possible will improve the evaluation performance of the model more obviously. Based on this, a simple strategy is to count the proportion of the abnormal point in the prediction sequence. If a predicted proportion of the abnormal point exceeds a quit threshold, it quits the detection and the current anomaly detection result is output, otherwise, a processing at a next level will be entered. However, this will make a large number of samples without an abnormal point enter a deeper model, which actually leads to a waste of computing resources.

In order to increase the model's recall for an abnormal point and reduce a proportion of the abnormal point as much as possible, we propose a dynamic quit mechanism based on bilateral thresholds. According to the confidence, it is determined whether to quit the detection ahead of time according to the bilateral thresholds.

In this application, the confidence threshold condition includes a first threshold and a second threshold; the first threshold is less than the second threshold; the confidence doing not meet the preset confidence threshold condition includes that the confidence is less than the first threshold, or the confidence is great than the second threshold; the confidence meeting the confidence threshold condition includes that the confidence is great than the first threshold and the confidence is less than the second threshold.

Illustratively, the first threshold and the second threshold are 0.2 and 0.8, respectively. If the confidence corresponding to the detection result is 0.1, it means that the detection result meets the threshold condition. If the confidence corresponding to the detection result is 0.6, it means that the detection result does not meet the preset condition. If the confidence corresponding to the detection result is 0.9, it means that the detection result meets the preset condition.

In this application, the collected system data is input into the system state detection model, and after the detection result is output by the deep-layer feature detection module of the model, the anomaly score of the detection result is calculated, and then the confidence is calculated, so that it is determined whether to quit the detection ahead of time is according to the confidence, that is, the detection result is output. The confidence between bilateral thresholds is considered as complex data, thus, the next deep-layer feature detection module can be used to continue monitoring, that is, not quitting the detection ahead of time. Otherwise, the determination result is credible, so that it quits the detection ahead of time and obtains the detection result. In this way, the security overhead of the system can be reduced while ensuring the detection efficiency. If the detection process has been propagated to the deep-layer feature detection module at a last level, the anomaly score output by the deep-layer feature detection module at the last level is the detection result. Therefore, the problem that the state detection efficiency of the existing industrial internet system is low and affects the production efficiency is solved, the detection efficiency of the system is improved, and the production cost and safety risk are reduced.

FIG. 5 is a schematic structural diagram of a system state detection system for an industrial internet system provided by an embodiment of the present application. Referring to FIG. 5, the system 50 includes a system data acquisition subsystem 510, a system state detection subsystem 520 and a system state alarm subsystem 530;
the system data acquisition subsystem 510 is configured to acquire system data of the industrial internet system and transmit the system data to the system state detection subsystem;
the system state detection subsystem 520 is configured to execute the system state detection method for the industrial internet system in the above embodiment;
the system state alarm subsystem 530 is used to alarm the system state output by the system state detection subsystem.

In an implementation, the system state detection subsystem 520, when detecting the system data by using the system state detection model to obtain the system state of the industrial internet system, is specifically configured to:
input shallow-layer feature corresponding to the system data into the shallow-layer feature extraction module to obtain corresponding shallow-layer feature extraction data;
for a deep-layer feature detection module at any level except a last level, input shallow-layer feature data output by the shallow-layer feature extraction module or a deep-layer feature detection module at a previous level to a deep-layer feature detection module at a current level for deep-layer feature extraction, and perform state detection on extracted deep-layer feature data to obtain a corresponding system state and a confidence corresponding to the system state;
in a case that the confidence does not meet a preset confidence threshold condition, output deep-layer feature data of the current level as shallow-layer feature data of a deep-layer feature detection module at a next level; and
in a case that the confidence meets the confidence threshold condition, output a detection state of the current level as the system state corresponding to the industrial internet system.

In an implementation, the deep-layer feature detection module at any level except the last level includes a deep-layer feature extraction and state detection submodule, and a detection result checking submodule;
where the deep-layer feature extraction and state detection submodule is configured to perform deep-layer feature extraction on the shallow-layer feature data output by the shallow-layer feature extraction module or the deep-layer feature detection module at the previous level, and perform state detection on the extracted deep-layer feature data to obtain the corresponding system state;
the detection result checking submodule is configured to obtain the confidence corresponding to the system state, wherein in the case that the confidence does not meet the preset confidence threshold condition, the deep-layer feature data of the current layer is taken as the shallow-layer feature data of the deep-layer feature detection module at the next level; and in the case that the confidence meets the confidence threshold condition, the system state corresponding to the industrial internet system is obtained.

In an implementation, the deep-layer feature extraction and state detection submodule includes a deep-layer feature extraction layer and a state detection layer, the deep-layer feature extraction layer is configured to perform deep-layer feature extraction on the shallow-layer feature data output by the shallow-layer feature extraction module or the deep-layer feature detection module at the previous level to obtain the deep-layer feature data; and
the state detection layer is configured to perform state detection on the extracted deep-layer feature data to obtain the corresponding system state.

In an implementation, the confidence threshold condition includes a first threshold and a second threshold; the first threshold is less than the second threshold;
the confidence doing not meet the preset confidence threshold condition includes that the confidence is less than the first threshold, or the confidence is great than the second threshold;
the confidence meeting the confidence threshold condition includes that the confidence is great than the first threshold and the confidence is less than the second threshold.

In an implementation, the system state detection subsystem 520 is further configured to:
train a constructed dynamic neural network model by using the training data set to obtain the system state detection model, where a loss function used in training includes regression loss, correlation difference loss and feature unwrapping loss, the correlation difference loss includes prior correlation loss and sequence correlation loss,
where the regression loss represents a difference between a reconstruction result of the historical system data output by the dynamic neural network model in a training process and the historical system data;
the prior correlation loss represents an attention weight distribution of a corresponding row of the historical system data in an attention matrix;
the sequence correlation loss represents a correlation between deep-layer feature data respectively corresponding to a current data point and a neighborhood domain data point in the historical system data;
the feature unwrapping loss represents a degree of correlation between deep-layer feature data corresponding to different data points in the historical system data.

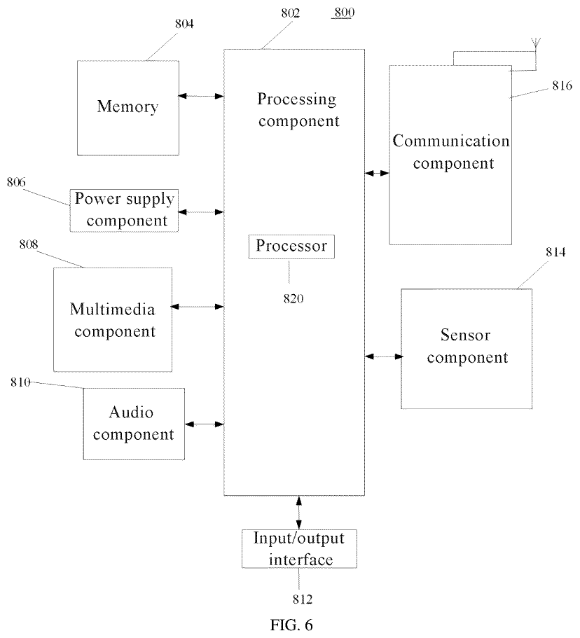

FIG. 6 is a block diagram of an electronic device provided by an embodiment of the present application, which may be a computer, a digital broadcasting terminal, etc.

Referring to FIG. 6, the device 800 may include one or more of the following components: a processing component 802, a memory 804, a power supply component 806, a multimedia component 808, an audio component 810, an input/output interface 812, a sensor component 814, and a communication component 816.

The processing component 802 generally controls the overall operation of the device 800, such as operations associated with display, telephone call, data communication, camera operation and recording operation. The processing component 802 may include one or more processors 820 to execute instructions to complete all or part of the steps of the method described above. In addition, the processing component 802 can include one or more modules to facilitate interaction between the processing component 802 and other components. For example, the processing component 802 can include a multimedia module to facilitate interaction between the multimedia component 808 and the processing component 802.

The memory 804 is configured to store various types of data to support operations at the device 800. Examples of these data include instructions for any application or method operating on the device 800, contact data, phone book data, messages, pictures, videos, and the like. The memory 804 can be realized by any type of volatile or nonvolatile memory device or their combination, such as Static Random-Access Memory (SRAM), electrically erasable programmable read-only memory (EEPROM), Erasable Programmable Read-Only Memory (EPROM), Programmable Read-Only Memory (PROM), Read-Only Memory (ROM), magnetic memory, flash memory, magnetic disk or optical disc.

The power supply component 806 provides power to various components of the device 800. The power supply component 806 may include a power management system, one or more power supplies, and other components associated with generating, managing and distributing power for the device 800.

The multimedia component 808 includes a screen that provides an output interface between the device 800 and the user. In some embodiments, the screen may include a Liquid Crystal Display (LCD) and a Touch Panel (TP). If the screen includes a touch panel, the screen may be implemented as a touch screen to receive an input signal from a user. The touch panel includes one or more touch sensors to sense touch, sliding and gestures on the touch panel. The touch sensor can not only sense the boundary of the touch or sliding action, but also detect the duration and pressure related to the touch or sliding operation. In some embodiments, the multimedia component 808 includes a front camera and/or a rear camera. When the device 800 is in an operation mode, such as a shooting mode or a video mode, the front camera and/or the rear camera can receive external multimedia data. Each front camera and rear camera can be a fixed optical lens system or have focal length and optical zoom capability.

The audio component 810 is configured to output and/or input audio signals. For example, the audio component 810 includes a Microphone (MIC) configured to receive external audio signals when the device 800 is in operation modes, such as a call mode, a recording mode and a voice recognition mode. The received audio signal may be further stored in the memory 804 or transmitted via the communication component 816. In some embodiments, the audio component 810 further includes a speaker for outputting audio signals.

Input/output interface 812 provides an interface between processing component 802 and peripheral interface modules, the above peripheral interface modules can be keyboards, clickwheels, buttons, etc. These buttons may include, but are not limited to, home button, volume button, start button and lock button.

The sensor component 814 includes one or more sensors for providing various aspects of the state evaluation for the device 800. For example, the sensor component 814 can detect the on/off state of the device 800, the relative positioning of components. For example, the components are display and keypad of the device 800, the position change of the device 800 or a component of the device 800, the presence or absence of user contact with the device 800, the orientation or acceleration/deceleration of the device 800 and the temperature change of the device 800 can be detected. The sensor component 814 may include a proximity sensor configured to detect the presence of a nearby object without any physical contact. The sensor component 814 may also include an optical sensor, such as an image solid (Complementary Metal Oxide Semiconductor CMOS) transducer or a semiconductor image (Charge-coupled Device, CCD) sensor, for use in imaging applications. In some embodiments, the sensor component 814 may further include an acceleration sensor, a gyro sensor, a magnetic sensor, a pressure sensor or a temperature sensor.

The communication component 816 is configured to facilitate wired or wireless communication between the device 800 and other devices. The device 800 can access a wireless network based on communication standards, such as WiFi, 4G or 5G, or a combination thereof. In an exemplary embodiment, the communication component 816 receives a broadcast signal or broadcast related information from an external broadcast management system via a broadcast channel. In an exemplary embodiment, the communication component 816 further includes a Near Field Communication (NFC) module to facilitate short-range communication. For example, the NFC module can be implemented based on Radio Frequency Identification (RFID) technology, Infrared Data Association (IrDA) technology, ultra-wide band (UWB) technology, Bluetooth (BT) technology and other technologies.

In an exemplary embodiment, the device 800 may be implemented by one or more application specific integrated circuits (ASIC), Digital Signal Processor (DSP), digital signal processing devices (DSP), Field Programmable Logic Device (PLD), controller, microcontroller, microprocessor or other electronic components, for executing the above method.

In an exemplary embodiment, there is also provided a non-transitory computer-readable storage medium including instructions, such as the memory 804 including instructions, which are executable by the processor 820 of the device 800 to complete the above method. For example, the non-transitory computer-readable storage medium can be ROM, Random Access Memory (RAM), CD-ROM, magnetic tape, floppy disk, optical data storage device, etc.

A non-transitory computer-readable storage medium, when instructions in the storage medium are executed by a processor of an electronic device, the electronic device is enabled to execute the above system state detection method for the industrial internet system.

The embodiment of the application also provides a chip for running instructions, the chip is configured to execute the technical scheme of the system state detection method for the industrial internet system in the above embodiment.

The embodiment of the application also provides a computer-readable storage medium, where the computer-readable storage medium stores computer executable instructions, and when the computer executable instructions run on a computer, the computer is enabled to execute the technical scheme of the system state detection method for the industrial internet system in the above embodiment.

The embodiment of the application also provides a computer program product, which includes a computer program stored in a computer-readable storage medium, and at least one processor can read the computer program from the computer-readable storage medium, and when the computer program is executed by at least one processor, the technical scheme of the system state detection method for the industrial internet system in the above embodiment can be realized.

Other embodiments of the present application will easily occur to those skilled in the art after considering the specification and practicing the application disclosed herein. This application is intended to cover any variations, usages or adaptations of this application, which follow the general principles of this application and include common sense or common technical means in this technical field that are not disclosed in this application. The specification and examples are to be regarded as exemplary only, with the true scope and spirit of the application being indicated by the following claims.

It should be understood that this application is not limited to the precise structure described above and shown in the drawings, and various modifications and changes can be made without departing from its scope. The scope of this application is limited only by the appended claims.

What is claimed is:

1. A system state detection method for an industrial internet system, comprising:
acquiring system data of the industrial internet system;
detecting the system data by using a system state detection model to obtain a system state of the industrial internet system; wherein the system state detection model comprises a shallow-layer feature extraction module and a plurality of deep-layer feature detection modules connected in sequence, the system state detection model is obtained by training a dynamic neural network model by using a training data set, the training data set comprises historical system data of the industrial internet system, and the system state comprises system normality and system abnormality; and
when the system state is system abnormality, outputting the system state of the industrial internet system.

2. The method according to claim 1, wherein detecting the system data by using the system state detection model to obtain the system state of the industrial internet system comprises:
inputting the system data into the shallow-layer feature extraction module to obtain corresponding shallow-layer feature extraction data;
for a deep-layer feature detection module at any level except a last level, inputting shallow-layer feature data output by the shallow-layer feature extraction module or a deep-layer feature detection module at a previous level to a deep-layer feature detection module at a current level for deep-layer feature extraction, and performing state detection on extracted deep-layer feature data to obtain a corresponding system state and a confidence corresponding to the system state;
when the confidence does not meet a preset confidence threshold condition, outputting deep-layer feature data of the current level as shallow-layer feature data of a deep-layer feature detection module at a next level; and
when the confidence meets the confidence threshold condition, outputting a detection state of the current level as the system state corresponding to the industrial internet system.

3. The method according to claim 2, wherein the deep-layer feature detection module at any level except the last level comprises a deep-layer feature extraction and state detection submodule, and a detection result checking submodule;
wherein the deep-layer feature extraction and state detection submodule is configured to perform deep-layer feature extraction on the shallow-layer feature data output by the shallow-layer feature extraction module or the deep-layer feature detection module at the previous level, and perform state detection on the extracted deep-layer feature data to obtain the corresponding system state; and
the detection result checking submodule is configured to obtain the confidence corresponding to the system state, wherein in the case that the confidence does not meet the preset confidence threshold condition, the deep-layer feature data of the current layer is taken as the shallow-layer feature data of the deep-layer feature detection module at the next level; and in the case that the confidence meets the confidence threshold condition, the system state corresponding to the industrial internet system is obtained.

4. The method according to claim 3, wherein the deep-layer feature extraction and state detection submodule comprises a deep-layer feature extraction layer and a state detection layer;
the deep-layer feature extraction layer is configured to perform deep-layer feature extraction on the shallow-layer feature data output by the shallow-layer feature extraction module or the deep-layer feature detection module at the previous level to obtain the deep-layer feature data; and
the state detection layer is configured to perform state detection on the extracted deep-layer feature data to obtain the corresponding system state.

5. The method according to claim 2, wherein the confidence threshold condition comprises a first threshold and a second threshold; the first threshold is less than the second threshold;
the confidence not meeting the preset confidence threshold condition comprises that the confidence is less than the first threshold, or the confidence is greater than the second threshold; and
the confidence meeting the confidence threshold condition comprises that the confidence is greater than the first threshold and the confidence is less than the second threshold.

6. The method according to claim 3, wherein the confidence threshold condition comprises a first threshold and a second threshold; the first threshold is less than the second threshold;
the confidence not meeting the preset confidence threshold condition comprises that the confidence is less than the first threshold, or the confidence is greater than the second threshold; and
the confidence meeting the confidence threshold condition comprises that the confidence is greater than the first threshold and the confidence is less than the second threshold.

7. The method according to claim 1, further comprising:
training a constructed dynamic neural network model by using the training data set to obtain the system state detection model, wherein a loss function used in training comprises regression loss, correlation difference loss and feature unwrapping loss, the correlation difference loss comprises prior correlation loss and sequence correlation loss,
wherein the regression loss represents a difference between a reconstruction result of the historical system data output by the dynamic neural network model in a training process and the historical system data;
the prior correlation loss represents an attention weight distribution of a corresponding row of the historical system data in an attention matrix;
the sequence correlation loss represents a correlation between deep-layer feature data respectively corresponding to a current data point and a neighborhood data point in the historical system data; and
the feature unwrapping loss represents a degree of correlation between deep-layer feature data corresponding to different data points in the historical system data.

8. The method according to claim 2, further comprising:
training a constructed dynamic neural network model by using the training data set to obtain the system state detection model, wherein a loss function used in training comprises regression loss, correlation difference loss and feature unwrapping loss, the correlation difference loss comprises prior correlation loss and sequence correlation loss,
wherein the regression loss represents a difference between a reconstruction result of the historical system data output by the dynamic neural network model in a training process and the historical system data;
the prior correlation loss represents an attention weight distribution of a corresponding row of the historical system data in an attention matrix;
the sequence correlation loss represents a correlation between deep-layer feature data respectively corresponding to a current data point and a neighborhood data point in the historical system data; and
the feature unwrapping loss represents a degree of correlation between deep-layer feature data corresponding to different data points in the historical system data.

9. A system state detection system for an industrial internet system, comprising: a system data acquisition subsystem, a system state detection subsystem, and a system state alarm subsystem;
wherein the system data acquisition subsystem is configured to acquire system data of the industrial internet system and transmit the system data to the system state detection subsystem;
the system state detection subsystem is configured to:
detect the system data by using a system state detection model to obtain a system state of the industrial internet system; wherein the system state detection model comprises a shallow-layer feature extraction module and a plurality of deep-layer feature detection modules connected in sequence, the system state detection model is obtained by training a dynamic neural network model by using a training data set, the training data set comprises historical system data of the industrial internet system, and the system state comprises system normality and system abnormality; and
when the system state is system abnormality, output the system state of the industrial internet system;
the system state alarm subsystem is configured to alarm the system state output by the system state detection subsystem.

10. The system state detection system according to claim 9, wherein the system state detection subsystem, when detecting the system data by using the system state detection model to obtain the system state of the industrial internet system, is configured to:
input shallow-layer feature corresponding to the system data into the shallow-layer feature extraction module to obtain corresponding shallow-layer feature extraction data;
for a deep-layer feature detection module at any level except a last level, input shallow-layer feature data output by the shallow-layer feature extraction module or a deep-layer feature detection module at a previous level to a deep-layer feature detection module at a current level for deep-layer feature extraction, and perform state detection on extracted deep-layer feature data to obtain a corresponding system state and a confidence corresponding to the system state;
when the confidence does not meet a preset confidence threshold condition, output deep-layer feature data of the current level as shallow-layer feature data of a deep-layer feature detection module at a next level; and
when the confidence meets the confidence threshold condition, output a detection state of the current level as the system state corresponding to the industrial internet system.

11. The system state detection system according to claim 10, wherein the deep-layer feature detection module at any level except the last level includes a deep-layer feature extraction and state detection submodule, and a detection result checking submodule;
the deep-layer feature extraction and state detection submodule is configured to perform deep-layer feature extraction on the shallow-layer feature data output by the shallow-layer feature extraction module or the deep-layer feature detection module at the previous level, and perform state detection on the extracted deep-layer feature data to obtain the corresponding system state; and
the detection result checking submodule is configured to obtains the confidence corresponding to the system state, wherein in the case that the confidence does not meet the preset confidence threshold condition, the deep-layer feature data of the current layer is taken as the shallow-layer feature data of the deep-layer feature detection module at the next level; and in the case that the confidence meets the confidence threshold condition, the system state corresponding to the industrial internet system is obtained.

12. The system state detection system according to claim 11, the deep-layer feature extraction and state detection submodule includes a deep-layer feature extraction layer and a state detection layer, the deep-layer feature extraction layer is configured to perform deep-layer feature extraction on the shallow-layer feature data output by the shallow-layer feature extraction module or the deep-layer feature detection module at the previous level to obtain the deep-layer feature data; and
the state detection layer is configured to perform state detection on the extracted deep-layer feature data to obtain the corresponding system state.

13. The system state detection system according to claim 10, wherein the confidence threshold condition includes a first threshold and a second threshold; the first threshold is less than the second threshold;
the confidence not meeting the preset confidence threshold condition includes that the confidence is less than the first threshold, or the confidence is greater than the second threshold; and
the confidence meeting the confidence threshold condition includes that the confidence is greater than the first threshold and the confidence is less than the second threshold.

14. The system state detection system according to claim 11, wherein the system state detection subsystem is further configured to:
train a constructed dynamic neural network model by using the training data set to obtain the system state detection model, where a loss function used in training includes regression loss, correlation difference loss and feature unwrapping loss, the correlation difference loss includes prior correlation loss and sequence correlation loss,
where the regression loss represents a difference between a reconstruction result of the historical system data output by the dynamic neural network model in a training process and the historical system data;
the prior correlation loss represents an attention weight distribution of a corresponding row of the historical system data in an attention matrix;
the sequence correlation loss represents a correlation between deep-layer feature data respectively corresponding to a current data point and a neighborhood domain data point in the historical system data; and
the feature unwrapping loss represents a degree of correlation between deep-layer feature data corresponding to different data points in the historical system data.

15. An electronic device, comprising: a processor and a memory communicatively connected with the processor;
the memory store computer executable instructions; and
the processor, when executing the computer executable instructions, is configured to:
acquire system data of the industrial internet system;
detect the system data by using a system state detection model to obtain a system state of the industrial internet system; wherein the system state detection model comprises a shallow-layer feature extraction module and a plurality of deep-layer feature detection modules connected in sequence, the system state detection model is obtained by training a dynamic neural network model by using a training data set, the training data set comprises historical system data of the industrial internet system, and the system state comprises system normality and system abnormality; and
when the system state is system abnormality, output the system state of the industrial internet system.

16. A non-transitory computer-readable storage medium, wherein the computer-readable storage medium stores computer executable instructions, and when the computer executable instructions are executed by a processor, the system state detection method for the industrial internet system according to claim 1 is implemented.

17. The non-transitory computer-readable storage medium according to claim 16, wherein when the computer executable instructions are executed by the processor, the processor is further configured to:
input the system data into the shallow-layer feature extraction module to obtain corresponding shallow-layer feature extraction data;
for a deep-layer feature detection module at any level except a last level, input shallow-layer feature data output by the shallow-layer feature extraction module or a deep-layer feature detection module at a previous level to a deep-layer feature detection module at a current level for deep-layer feature extraction, and perform state detection on extracted deep-layer feature data to obtain a corresponding system state and a confidence corresponding to the system state;
when the confidence does not meet a preset confidence threshold condition, output deep-layer feature data of the current level as shallow-layer feature data of a deep-layer feature detection module at a next level; and
when the confidence meets the confidence threshold condition, output a detection state of the current level as the system state corresponding to the industrial internet system.

18. The non-transitory computer-readable storage medium according to claim 17, wherein the deep-layer feature detection module at any level except the last level comprises a deep-layer feature extraction and state detection submodule, and a detection result checking submodule;
wherein the deep-layer feature extraction and state detection submodule is configured to perform deep-layer feature extraction on the shallow-layer feature data output by the shallow-layer feature extraction module or the deep-layer feature detection module at the previous level, and perform state detection on the extracted deep-layer feature data to obtain the corresponding system state; and
the detection result checking submodule is configured to obtain the confidence corresponding to the system state, wherein in the case that the confidence does not meet the preset confidence threshold condition, the deep-layer feature data of the current layer is taken as the shallow-layer feature data of the deep-layer feature detection module at the next level; and in the case that the confidence meets the confidence threshold condition, the system state corresponding to the industrial internet system is obtained.

19. A computer program product, wherein the computer program product comprises a computer program which, when executed by a processor, implements the system state detection method for the industrial internet system according to claim 1.

20. The computer program product according to claim 19, wherein the computer program, when executed by the processor, the processor is further configured to:
input the system data into the shallow-layer feature extraction module to obtain corresponding shallow-layer feature extraction data;
for a deep-layer feature detection module at any level except a last level, input shallow-layer feature data output by the shallow-layer feature extraction module or a deep-layer feature detection module at a previous level to a deep-layer feature detection module at a current level for deep-layer feature extraction, and perform state detection on extracted deep-layer feature data to obtain a corresponding system state and a confidence corresponding to the system state;
when the confidence does not meet a preset confidence threshold condition, output deep-layer feature data of the current level as shallow-layer feature data of a deep-layer feature detection module at a next level; and
when the confidence meets the confidence threshold condition, output a detection state of the current level as the system state corresponding to the industrial internet system.
